(19) United States
(12) Patent Application Publication
(10) Pub. No.: US 2024/0066797 A1
(43) Pub. Date: Feb. 29, 2024

(54) APPARATUS AND METHOD FOR PERFORMING 3D PRINTING BY TAPPET DISPENSING

(71) Applicant: Markforged, Inc, Watertown, MA (US)

(72) Inventors: Maxim Seleznev, Arlington, MA (US); Joseph Roy-Mayhew, Watertown, MA (US); Benjamin Gallup, Acton, MA (US); Yuwei Li, Cambridge, MA (US); Michael Imburgia, Medford, MA (US)

(21) Appl. No.: 17/893,492

(22) Filed: Aug. 23, 2022

(51) Int. Cl. B29C 64/209; B29C 64/295; B29C 64/321; B29C 64/35; B33Y 10/00; B33Y 30/00

(52) U.S. Cl. CPC B29C 64/209; B29C 64/295; B29C 64/321; B29C 64/35; B33Y 10/00; B33Y 30/00; B29C 64/118

(57) ABSTRACT

A 3D printing apparatus and method includes a piezo actuator that reciprocates a tappet. The reciprocation of the tappet generates pressure within a chamber filled with molten print material. The generated pressure causes the molten print material to be extruded through a nozzle coupled to the chamber. The piezo actuator is controlled to switchably provide continuous extrusion of print material or extrusion of discrete droplets of print material.

### FIELD OF THE INVENTION

The invention relates to an apparatus and method for performing 3D printing of a part using tappet dispensing.

### BACKGROUND OF THE INVENTION

Existing 3D printing methodologies, such as fused filament fabrication (FFF), suffer from a serious drawback of low production rate. This occurs because the material extrusion rate is likewise low. It is difficult to quickly change the extrusion rate in existing FFF approaches.

There are at least two underlying causes behind the limitation of the low extrusion rate: (i) low pressure and (ii) low stiffness, of the extrusion mechanism. Existing FFF approaches generally employ a pinch wheel mechanism (PWM) to extrude molten material. The PWM pushes filament through a hot nozzle. In many existing implementations, PWM may be a low pressure arrangement, with low extrusion pressure of the molten material entering the nozzle and a low extrusion pressure threshold before the PWM slips against or grinds the filament surface. In addition, a PWM drive motor may stall or skip (e.g., if using a stepper) or some internal component may also slip.

In many existing implementations, PWM may also be a low stiffness system, which may result in accuracy problems. The indirect nature of PWM control occurs because pressure must first accumulate before extrusion takes place, and pressure must also be vented to stop the extrusion. Therefore, difficulties arise with precise dispensing of molten print material during printing because extrusion in a PWM system is controlled indirectly. That is, neither the building of pressure nor the venting of pressure occurs immediately. While the accuracy problems may be less pronounced when printing long extrusion paths that avoid abrupt print starts and stops during printing, these accuracy problems become more severe when abrupt print starts and stops are employed. Moreover, winding extrusion paths result in frequent printhead accelerations and decelerations, which limit printing speed due to mechanical limitations in precise position control of a gantry system that moves the print head.

Thus, the slow and difficult-to-anticipate reaction between issuance of a control command and the actual corresponding physical reaction limits the extrusion rate, thereby limiting production rate. Additionally, frequent nozzle clogging can occur, which can interrupt or even ruin the printing process. Although various alternative PWM geometries, such as wider diameter wheels, more teeth, and/or dual wheels have been considered to address the clogging problem, these approaches have not had overall success.

Ultimately, these limitations in conventional FFF printing result in complicated control of extruded line thickness and possible printed part surface quality issues.

With respect to existing tappet systems, these systems produce discontinuous droplets and are generally intended for dispensing solder pastes or molten polymers (hot glues) in a discontinuous droplet jetting (DDJ) regime.

As such, there is a need for a 3D printing system (e.g., FFF or material extrusion (MEX) such as non-molten material MEX) that can provide high extrusion pressure and precision control of molten print material dispensing.

### SUMMARY OF THE INVENTION

One aspect of the present invention relates to a 3D printing apparatus comprising a controller; a dispensing mechanism configured to dispense 3D print material, wherein the dispensing mechanism includes: a driver, a chamber configured to accommodate the driver therein, the chamber including an input port configured to receive 3D print material entering the chamber and an output port configured to provide 3D print material exiting the chamber, and a driving mechanism that drives the driver with reciprocating movement within the chamber, based on signals from the controller, wherein the reciprocation of the driver causes print material within the chamber to exit the chamber via the output port; and a nozzle coupled to the output port.

Another aspect of the present invention relates to a method for 3D printing, comprising controlling a dispensing mechanism configured to dispense 3D print material, including: controlling, based on signals from a controller, a driving mechanism to drive a driver with reciprocating movement within a chamber, the chamber including an input port configured to receive 3D print material entering the chamber and an output port configured to provide 3D print material exiting the chamber, wherein the reciprocation of the driver causes print material within the chamber to exit the chamber via the output port.

These and other aspects of the invention will become apparent from the following disclosure.

### BRIEF DESCRIPTION OF THE DRAWINGS

FIGS. 1A and 1C illustrate an apparatus, in accordance with one embodiment, and FIGS. 1B and 1D illustrate an apparatus, in accordance with one embodiment.

FIGS. 2A and 2B illustrate an actuated tappet dispensing (ATD) mechanism, in accordance with one embodiment, and FIG. 2C illustrates an ATD mechanism, in accordance with one embodiment.

FIG. 3A illustrates an arrangement of an ejection of a droplet of print material from the ATD mechanism, in accordance with one embodiment, and FIGS. 3B-3D illustrate exemplary results of ejected droplets on a target surface.

FIG. 4 is a flow chart for continuous extrusion printing, in accordance with one embodiment.

FIG. 5 is a flow chart for raster pattern printing, in accordance with one embodiment.

FIG. 6 is a flow chart for vector continuous printing, in accordance with one embodiment.

FIG. 7 is a flow chart for mixed raster pattern and vector printing, in accordance with one embodiment.

FIG. 8 is a flow chart for mixed raster pattern and vector printing, in accordance with one embodiment.

FIG. 9A is a flow chart for mixed raster pattern and vector printing, in accordance with one embodiment.

FIG. 9B is a flow chart for mixed raster pattern and vector printing, in accordance with one embodiment.

FIG. 10 is a flow chart for gap bridging printing, in accordance with one embodiment.

FIG. 11 is a flow chart for multi-nozzle printing, in accordance with one embodiment.

FIG. 12 illustrates cleaning of a nozzle, in accordance with one embodiment.

FIG. 13 is a flow chart for spot correction printing, in accordance with one embodiment.

### DETAILED DESCRIPTION OF THE PREFERRED EMBODIMENTS

3D Printer Apparatus

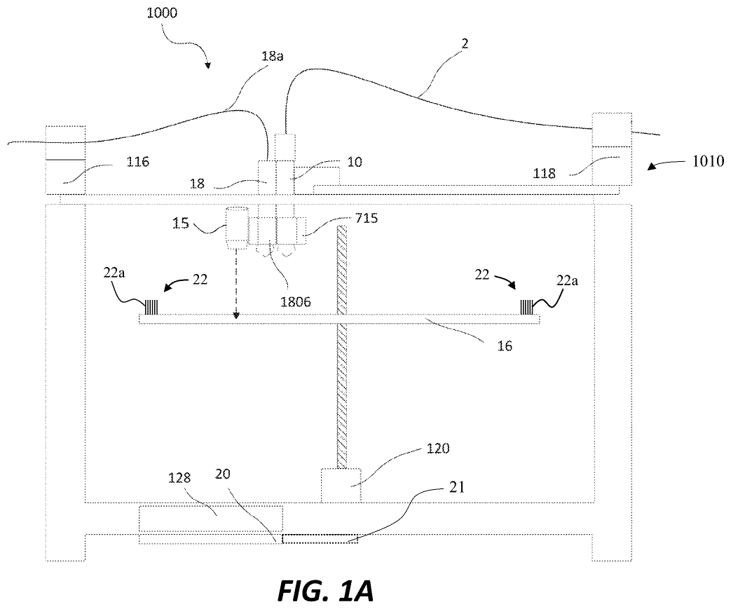

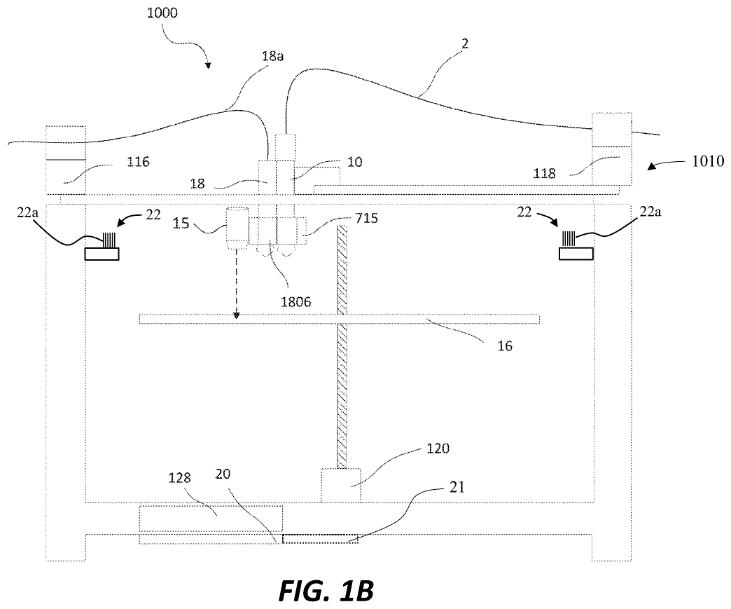

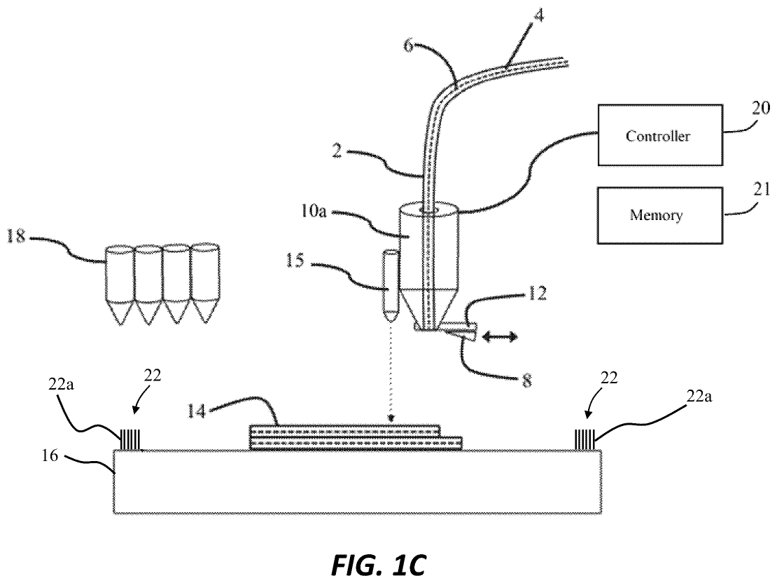

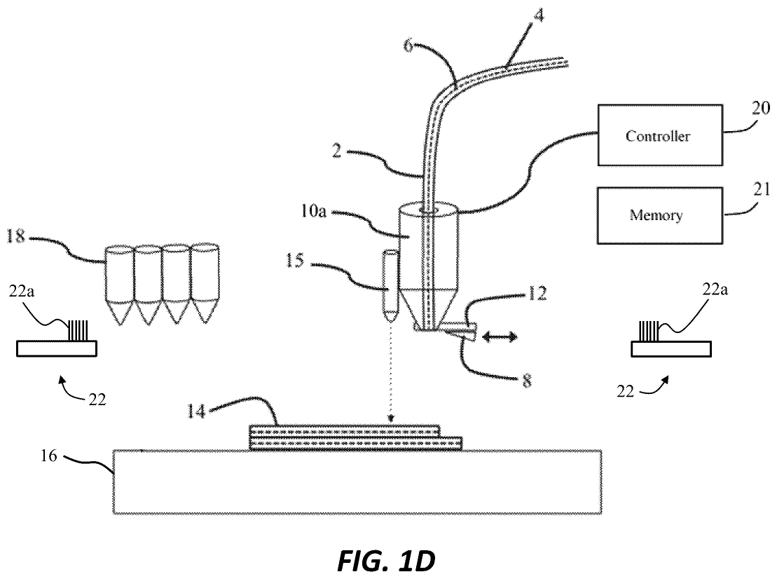

FIGS. 1A and 1C illustrate an apparatus 1000 in accordance with one embodiment of the invention, and FIGS. 1B and 1D illustrate the apparatus 1000 in accordance with another embodiment of the invention. The apparatus 1000 includes one or more controllers 20, one or more memories 21, and one or more print heads 10, 18. For instance, one head 10 may deposit a metal or fiber reinforced composite filament 2, and another head 18 may apply pure or neat matrix resin 18a (thermoplastic or curing), which may include, but is not limited to, a polymer or curable monomer and/or a polymer or curable monomer filled, e.g., with chopped carbon fiber, carbon black, silica, and/or aramid fiber. In the case of the filament 2 being a fiber reinforced composite filament, such filament (also referred to herein as continuous core reinforced filament) may be substantially void free and include a polymer or resin that coats, permeates or impregnates an internal continuous core (including, but not limited to, single, multi-strand, or multi-material). It should be noted that although the print head 18 is shown as an extrusion print head, “fill material print head” 18 as used herein includes optical, UV, or thermal curing, heat fusion or sintering, or “polyjet”, liquid, colloid, suspension or powder jetting devices (not shown) for depositing fill material. It will also be appreciated that a material bead formed by the filament 2 may be deposited as extruded thermoplastic or metal, deposited as continuous or semi-continuous fiber, solidified as photo, UV, or thermally cured resin, or jetted as metal or binders mixed with plastics or metal, or are structural, functional or coatings. The fiber reinforced composite filament 2 (also referred to herein as continuous core reinforced filament) may be a push-pulpreg that is substantially void free and includes a polymer or resin 4 that coats or impregnates an internal continuous single core or multi-strand core 6. The apparatus includes heaters 715, 1806 to heat the print heads 10, 18, respectively so as to facilitate deposition of layers of material to form the object 14 to be printed. A cutter 8 controlled by the controller 20 may cut the filament 2 during the deposition process in order to (i) form separate features and components on the structure as well as (ii) control the directionality or anisotropy of the deposited material and/or bonded ranks in multiple sections and layers. As depicted, the cutter 8 is a cutting blade associated with a backing plate 12 located at the nozzle outlet. Other cutters include laser, high-pressure air or fluid, or shears. The apparatus 1000 may also include additional non-printing tool heads, such as for milling, SLS, etc.

The apparatus 1000 includes a gantry 1010 that supports the print heads 10, 18. The gantry 1010 includes motors 116, 118 to move the print heads 10, 18 along X and Y rails in the X and Y directions, respectively. The apparatus 1000 also includes a build platen 16 (e.g., print bed) on which an object to be printed is formed. The height of the build platen 16 is controlled by a motor 120 for Z direction adjustment. Although the movement of the apparatus has been described based on a Cartesian arrangement for relatively moving the print heads in three orthogonal translation directions, other arrangements are considered within the scope of, and expressly described by, a drive system or drive or motorized drive that may relatively move a print head and a build plate supporting a 3D printed object in at least three degrees of freedom (i.e., in four or more degrees of freedom as well). For example, for three degrees of freedom, a delta, parallel robot structure may use three parallelogram arms connected to universal joints at the base, optionally to maintain an orientation of the print head (e.g., three motorized degrees of freedom among the print head and build plate) or to change the orientation of the print head (e.g., four or higher degrees of freedom among the print head and build plate). As another example, the print head may be mounted on a robotic arm having three, four, five, six, or higher degrees of freedom; and/or the build platform may rotate, translate in three dimensions, or be spun.

The apparatus 1000 also includes one or more cleaning stations 22 for removing residual print material from the nozzles of the print head 10 and/or the print head 18 after the respective print head has been used to deposit print material. In one embodiment (illustrated in FIGS. 1A and 1C), some or all of the cleaning stations 22 are provided on the build platen 16. In one embodiment (illustrated in FIGS. 1B and 1D), some or all of the cleaning stations 22 are provided on the base and/or side of the apparatus 1000, such as being mounted to the frame of the apparatus 1000 or provided as a stationary component outside of the apparatus 1000. In one embodiment, one or more (or all) cleaning stations 22 each includes one or more brushes 22a. In one embodiment, one or more (or all) cleaning stations 22 each includes one or more of an air jet, a water jet, a solvent bath, an ultrasonic bath, hot gas, and/or a flame. In one embodiment (illustrated in FIGS. 1B and 1D), some or all of the 22a are provided on the base and/or side of the apparatus 1000 such that the brushes 22a are located in the same plane as the nozzles of the print head(s). It will also be appreciated that some or all of the brushes 22s may be mounted anywhere on the build platen 16, and/or may be mounted on the gantry 1010 or any other articulated motion platform, and/or may be mounted on any stationary component of the apparatus 1000 accessible by the print head(s).

In one embodiment as illustrated in FIGS. 1A and 1C, at least two cleaning stations 22 are provided on the build platen 16. In one embodiment, the cleaning stations 22 are positioned at opposing end portions of the build platen 16. In one embodiment, a first cleaning station 22 is positioned at a left end portion of the build platen 16, and a second cleaning station 22 is positioned at a right end portion of the build platen 16. In one embodiment, four cleaning stations 22 are provided on the build platen 16, each cleaning station positioned at a respective side of the build platen 16. In one embodiment, one or more (or all) cleaning stations 22 are each arranged as a continuous strip to collectively form a frame around the perimeter of the build platen 16, thereby collectively forming a perimeter cleaning mechanism (e.g., when four cleaning stations 22 are provided for a rectangular build platen).

In one embodiment as illustrated in FIGS. 1B and 1D, at least two cleaning stations 22 are mounted on the side of the apparatus 1000. In one embodiment, the cleaning stations 22 are positioned at opposing end sides of the apparatus 1000. In one embodiment, a first cleaning station 22 is positioned at a left end side of the apparatus 1000, and a second cleaning station 22 is positioned at a right end side of the apparatus 1000. In one embodiment, four cleaning stations 22 are provided on the apparatus 1000, each cleaning station positioned at a respective side of the apparatus 1000. In one embodiment, one or more (or all) cleaning stations 22 are each arranged as a continuous strip to collectively form a frame around the perimeter of the apparatus 1000, thereby collectively forming a perimeter cleaning mechanism (e.g., when four cleaning stations 22 are provided for a rectangular-shaped apparatus 1000).

In an embodiment where a cleaning station 22 includes one more brushes 22a, the brushes 22a are formed of bristles facing upward, which are suitable for loosening and releasing print material from the nozzle of a print head. In one embodiment, the brushes 22a are formed of metal such as brass or steel. In one embodiment, the brushes 22a in the apparatus are all formed of the same bristle material, bristle height, bristle stiffness, bristle shape/profile, and/or bristle density. In one embodiment, at least one brush 22a in the apparatus different in bristle material, bristle height, and/or bristle density from another brush 22a in the apparatus. In one embodiment, one or more (or even all) of the brushes 22a in the apparatus are detachable from the apparatus to facilitate cleaning of residual print material from the brushes and/or periodic replacement of the brushes. In one embodiment, one or more (or even all) of the brushes 22a are adjustable (e.g., in height and/or other position) via an adjustment mechanism. In one embodiment, one or more (or even all) of the brushes 22a are automatically adjustable (e.g., in height and/or other position), such as based on a tracked amount of use or an inspection or monitoring of the brushes 22a. In one embodiment, the apparatus 1000 may perform periodic inspection of one or more (or all) of the brushes 22 via a sensor (e.g., optical sensor) to determine which portions of the brushes 22 are relatively tainted with residual material and which portions are relatively clean, so as to control the nozzle cleaning to be performed in the clean portions rather than in the tainted portions.

FIG. 1C-1D depict embodiments of the apparatus 1000 applying the filament 2 to build a structure, with FIG. 1C based on the arrangement of FIG. 1A where the cleaning stations 22 are provided on the build platen 16 and FIG. 1D based on the arrangement of FIG. 1B where the cleaning stations 22 are mounted on the frame of the apparatus 1000. In one embodiment, the filament 2 is a metal filament for printing a metal object. In one embodiment, the filament 2 is a fiber reinforced composite filament (also referred to herein as continuous core reinforced filament) may be a push-pulpreg that is substantially void free and includes a polymer or resin 4 that coats or impregnates an internal continuous single core or multi-strand core 6. In one embodiment, the filament 2 is a discontinuously reinforced matrix material.

The filament 2 is fed through a nozzle 10a disposed at the end of the print head 10 and heated to extrude the filament material for printing. In the case that the filament 2 is a fiber reinforced composite filament, the filament 2 is heated to a controlled push-pultrusion temperature selected for the matrix material to maintain a predetermined viscosity, and/or a predetermined amount force of adhesion of bonded ranks, and/or a surface finish. The push-pultrusion may be greater than a melting temperature of the polymer 4, less than a decomposition temperature of the polymer 4 and less than either a melting or decomposition temperature of the core 6.

After being heated in the nozzle 10a and having its material substantially melted, the filament 2 is applied onto the build platen 16 to build successive layers 14 to form a three dimensional structure. One or both of (i) the position and orientation of the build platen 16 or (ii) the position and orientation of the nozzle 10a are controlled by a controller 20 to deposit the filament 2 in the desired location and direction. Position and orientation control mechanisms include gantry systems, robotic arms, and/or H frames, any of these equipped with position and/or displacement sensors to the controller 20 to monitor the relative position or velocity of nozzle 10a relative to the build platen 16 and/or the layers 14 of the object being constructed. The controller 20 may use sensed X, Y, and/or Z positions and/or displacement or velocity vectors to control subsequent movements of the nozzle 10a or platen 16. The apparatus 1000 may optionally include a laser scanner 15 to measure distance to the platen 16 or the layer 14, displacement transducers in any of three translation and/or three rotation axes, distance integrators, and/or accelerometers detecting a position or movement of the nozzle 10a to the build platen 16. The laser scanner 15 may scan the section ahead of the nozzle 10a in order to correct the Z height of the nozzle 10a, or the fill volume required, to match a desired deposition profile. This measurement may also be used to fill in voids detected in the object. The laser scanner 15 may also measure the object after the filament is applied to confirm the depth and position of the deposited bonded ranks. Distance from a lip of the deposition head to the previous layer or build platen, or the height of a bonded rank may be confirmed using an appropriate sensor.

Various 3D-printing aspects of the apparatus 1000 are described in detail in U.S. Patent Application Publication No. 2019/0009472, which is incorporated by reference herein in its entirety.

Actuated Tappet Dispensing Mechanism

In one aspect of the invention, the print head 10 (e.g., including the nozzle 10a and the heater 715) is configured as an actuated tappet dispensing (ATD) mechanism to extrude 3D printing material from the nozzle 10a. The ATD mechanism may include a nozzle end where a nozzle is provided, the nozzle end being positioned a distance from a target surface to which molten plastic-based material is to be deposited. In one embodiment, the distance between the nozzle end of the ATD mechanism and the target surface is less than an internal diameter of the nozzle.

In one embodiment, the ATD mechanism is configured to prevent discrete droplet jetting when desirable. For example, each portion of molten 3D printing material (e.g., plastic-based) extruded from the nozzle may be fused with the previously-extruded portion and does not break free from the nozzle. As a result, extruded portions may form a substantially continuous bead (line) on a target surface. Nonetheless, if discrete droplets are desirable for producing particular geometries (e.g., a very fine feature producible only using a single pulse of the ATD mechanism), the ATD mechanism may be configured with the capability to produce one or more discrete droplets that are not fused with previously-extruded portions. For instance, the ATD mechanism may be configured with the capability to deposit an individual discrete droplet of print material of approximately 300 μm in diameter.

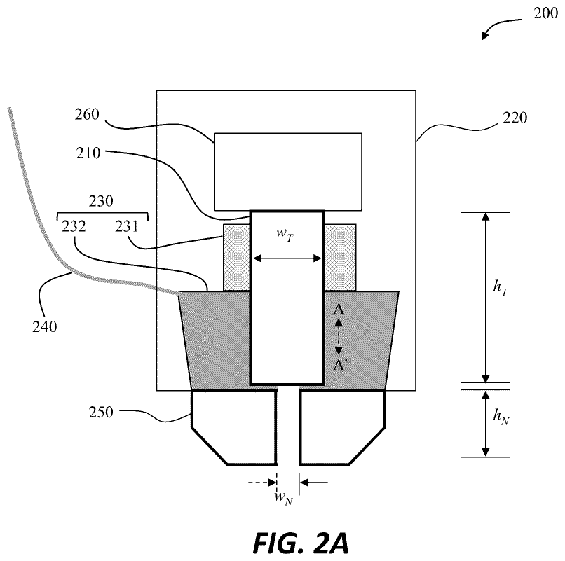

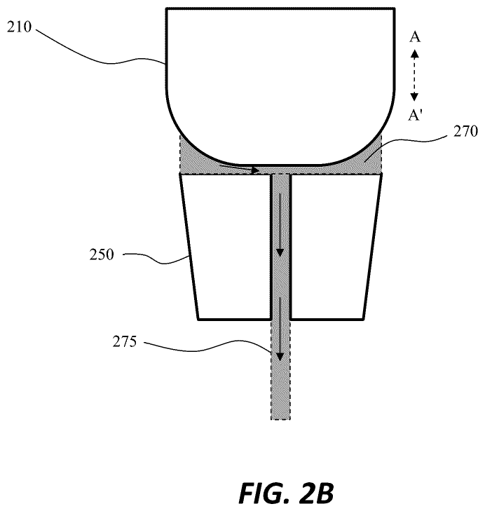

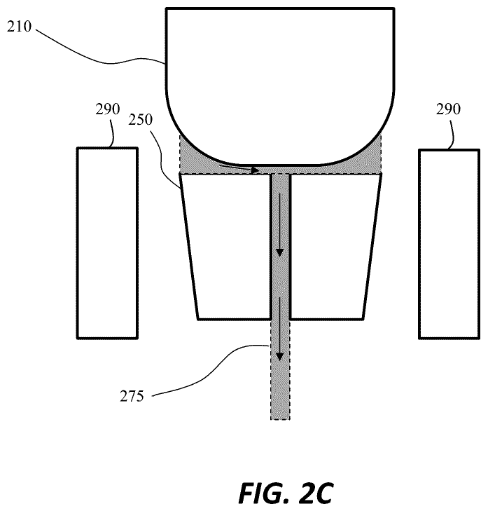

FIG. 2A illustrates an ATD mechanism 200 in accordance with an embodiment of the invention. The ATD mechanism 200 may include a tappet 210, a housing 220, a chamber 230, a feeding channel 240, a nozzle 250, and a piezo actuator 260. The tappet 210 may be implemented as a metal, carbide, or ceramic rod, may be circular, square, or rectangular in cross-section, and may have a height h_{T} and a width w_{T}. The tappet 210 is driven by the piezo actuator 260 to move reciprocally in the vertical (A-A′) direction.

The housing 220 encapsulates the tappet 210, chamber 230, and piezo actuator 260 to protect these components from adverse environmental conditions and other potential sources of damage.

The chamber 230 concentrically surrounds the tappet 210 and establishing a cavity for accumulating print material based on movement of the tappet 210. The chamber 230 may include a housing that defines the cavity. The housing may be preferably formed of metal, but may be alternatively formed of other materials. The chamber 230 may also include a seal 231 and a melt zone 232. The seal 231 prevents melted printed material from escaping the chamber 230. The seal 231 is preferably formed of one or more of PTFE (also known as Teflon®), graphite, fluorocarbon-based fluoroelastomer materials (FKM) such as Viton®, perfluoroelastomers (FFKM) such as Kalrez®, ethylene-propylene rubber (EPDM), grease, silicone rubber, and/or BUNA rubber, but may be alternatively formed of other materials. In one embodiment, the seal 231 is formed of one or more materials that include a filler (e.g., silica). In one embodiment, the seal 231 includes a thin metal flange as a part thereof.

The housing 220 includes one or more heating elements (not shown) that operate as a heat source to melt the print material in the melt zone 232. The housing 220 may correspond to the heater 715 illustrated in FIGS. 1A and 1C. The melt zone 232 may be continuously provided with print material (e.g., plastic-based) from a source external to the ATD mechanism via the feeding channel 240, such that the housing 220 melts print material into a molten state in the melt zone 232 when the print material enters the chamber 230. The melt zone 232 (or at least a portion thereof, such as the bottom portion) may be tapered in the downward direction so as to improve the conveyance throughput of print material during operation of the tappet 210. In one embodiment, the molten print material may contain one or more filler materials (including but not limited to particles or fibers). In one embodiment, the molten print material does not contain a filler.

The feeding channel 240 guides print material from a print material source towards the chamber 230. The feeding channel 240 may include an advancement mechanism (not shown) to advance a filament of print material into the chamber 230. Such an advancement mechanism may include, but is not limited to, one or more of pinch drive/idler wheels, a piston/cylinder system, a screw-based feeder, a gas-pressurized assembly, a drive belt, a screw, and/or an auger. The housing 220 may include a passthrough to allow the feeding channel 240 to feed print material from outside of the housing into the interior of the housing. The use of the chamber 230 and its melt zone 232 allows for continuous feeding of print material into the system, which eliminates the need to pause, reload the feedstock, and heat for a period to re-equilibrate the print material. For instance, even if a quantity of feedstock (e.g., spool) being driven through the feeding channel 240 has been depleted, the melt zone 232 continues to contain a supply of molten print material to continue the printing operation, and a user can reload a new quantity of feedstock for feeding the feeding channel 240 without interrupting an ongoing printing operation. Nonetheless, this arrangement also still allows for periodic reloading of feedstock (e.g., in batches).

The nozzle 250 provides a channel for directing print material 270 (see FIG. 2B) from the melt zone 232 out of the ATD mechanism 200 to the target surface as extruded print material 275, and may correspond to the nozzle 10a illustrated in FIGS. 1B and 1D. The nozzle 250 includes an entrance orifice coupled to the chamber 230 (e.g., at the melt zone 232), an exit orifice directed out of the ATD mechanism 200, and an internal channel between the entrance orifice and exit orifice. The internal channel may have a height h_{N} and a width w_{N}. In one embodiment, the width w_{T} of the tappet 210 is larger than the width w_{N} (e.g., at the entrance orifice) of the internal channel (i.e., w_{T}>w_{N}). In one embodiment, the internal channel is between a fraction of a millimeter to several millimeters long. In one embodiment, the nozzle 250 is tapered in its exterior profile. In one embodiment, the nozzle 250 is tapered in its exterior profile while its internal channel may be tapered or non-tapered (e.g., cylindrical or rectangular prism). In one embodiment, the entrance orifice has a diameter of approximately 320 μm and the exit orifice has a diameter of approximately 300 μm. In one embodiment, the nozzle 250 is formed of ceramic, silicon carbide, silicon nitride, alumina, diamond-coated steel, tool steel, D2 steel, titanium, aluminum, aluminum alloys, copper, copper alloys, and/or a combination of the foregoing. In one embodiment, the nozzle 250 and/or the tappet 210 are formed of hardened materials (e.g., silicon carbon, tungsten carbide, tungsten, tool steels, diamond, etc., or a combination thereof), which may provide for the processing of highly filled materials including metal injection molding and ceramic injection molding feedstocks.

The piezo actuator 260 is coupled to, and drives, the tappet 210 such that the tappet 210 undergoes reciprocating movement within the chamber 230. As illustrated in FIG. 2B, the tappet 210 approaches the entrance orifice of the nozzle 250 during its reciprocal movement, so as to drive molten print material into the entrance orifice of the nozzle 250 such that molten print material 275 is extruded from the exit orifice of the nozzle 250. That is, the molten print material is ejected in portions through the nozzle every time the reciprocating tappet 210 approaches the nozzle entrance orifice, and such reciprocating movement of the tappet 210 generates high pressure for molten print material 270 (e.g., approximately 0.1 MPa to 1 MPa, and up to about 100 MPa) at the entrance orifice of the nozzle 250, thereby facilitating extrusion.

The piezo actuator 260 may be implemented as, for example, a piezoelectric ceramic stack through a mechanical lever system, a precisely controlled pneumatic system, and/or any mechanical, electromechanical, pulsing pneumatic, or pulsing hydraulic system or combination thereof.

With respect to the advancement mechanism of the feeding channel 240, such mechanism may incorporate various approaches to advance print material. In one embodiment, the advancement mechanism may periodically feed print material in successive batches. In one embodiment, the advancement mechanism may continuously feed print material. For instance, rather than feeding material such as a filament in batches (where the system may need to stop, reload material, wait for melting, then resume), the continuous feed mode may deliver molten print material directly into the chamber 230. In one embodiment, such delivery may be accomplished by the advance mechanism including an additional small reservoir that pre-melts incoming print material approaching the APD mechanism 200, such that the print material is already molten when it advances from the small reservoir to enter the chamber 230.

In one embodiment, the ATD mechanism ejects discrete droplets which are deposited on the target surface to form a continuous trace, and the droplets are then plowed, using a plowing mechanism 290 (see FIG. 2C), into a flat-top bead having an exact pre-determined height (layer height). The plowing mechanism 290 may include, but is not limited to, a shroud that concentrically surrounds the nozzle, e.g., with the nozzle positioned within the shroud. In one embodiment, the shroud extends vertically below the bottom-most position of the nozzle 250. In one embodiment, the height of the bottom-most portion of the shroud relative to the target surface generally corresponds to the desired layer height. In one embodiment, the shroud has a circular cross-sectional profile. In one embodiment, the shroud has a non-circular cross-sectional profile. In one embodiment, the shroud is a unified component. In one embodiment, the shroud is formed of multiple segments, which may facilitate cleaning of residual print material from the shroud.

The foregoing approaches are especially applicable to FFF printing. For instance, the advancement mechanism may include a PWM that pushes the filament through a heated liquefier block/tube, into the feeding channel 240 and then the chamber 230. The advancement mechanism may be controlled to maintain pressure, e.g., 1-10 MPa (e.g., via load cells or pressure gauges), and the PWM may be controlled based on a commanded extrusion rate. It will nonetheless be appreciated that while the above description is made with reference to a filament print material, the present invention may be used with other forms of print material including, but not limited to, pellets based on a screw system or a melt pump.

General advantages of the actuated tappet dispensing system according to the present invention include (i) high pressure (e.g., which may be an order of magnitude or higher than conventional 3D printing extrusion), (ii) high dispensing rate, (iii) high stiffness, and (iv) straightforward and accurate control, e.g., down to a single cyclic movement of a tappet at a wide range of frequencies such as (but not limited to) 1 kHz or higher, 0.5 kHz or higher, 0.1 kHz or higher, or even frequencies lower than 0.1 kHz.

Such operation allows achieving high printing speeds, improved control, and quality through material extrusion (MEX) (including non-molten material MEX such as, but not limited to, solvent-deposited, water-based, and/or thermoset materials) and/or fused filament fabrication (FFF) for a 3D printing process.

For example, specific advantages that may be achieved by the present invention include, but are not limited to, (i) precise control over deposited material bead thickness and width (i.e., layer height and bead width), (ii) the nozzle through which material is extruded acting as a doctor blade forcing and shearing extruded bead to a predetermined bead thickness (i.e., layer height), (iii) improved fusion and adhesion of the bead being deposited on prior deposited bead material or the target surface, (iv) the material extruded nozzle acting as a doctor blade facilitating enhanced contact, and/or (v) reduced excess material being stuck to the nozzle, which could otherwise occur in PWM filament extrusion systems especially during high-speed 3D printing.

In one embodiment, the ATD mechanism 200 may be packaged as a module. Advantages to this approach may include providing the ATD mechanism 200 as an end-effector-like component mounted to the print head. Such approach allows the ATD mechanism 200 to be compatibly mountable on any positioning system (including applications beyond 3D printing) that provides power and data to its end effector.

Various operations may be performed using the ATD mechanism with respect to MEX and/or FFF 3D printing including, but not limited to:
a continuous extrusion printing mode;
a raster pattern printing mode;
a vector continuous printing mode;
a mixed raster pattern and vector printing mode;
a gap bridging printing mode;
a multi-nozzle printing mode;
a continuous filament-fed operation mode;
a perimeter nozzle cleaning for raster pattern printing mode;
spot correction, with or without optical detection and feedback;
predictive and/or real time control of extrusion bead width;
packaging as a module;
printing of overhang geometries; and/or
printing of a separate perimeter for the removal of unwanted extrudate.
   Aspects of these operations will be described below.

Improved Droplet Accuracy Control and Instantaneous Stop Start Printing Advantages Using the Present Invention

In one aspect of the present invention, the discrete portions (e.g., droplets) of molten material are confined within a constrained space when they are ejected. For instance, the ejected droplets may be constrained between the end of the nozzle 250 and the target surface (e.g., build platen 16 or prior layer of print material), rather than breaking, free falling, and/or flying from the nozzle.

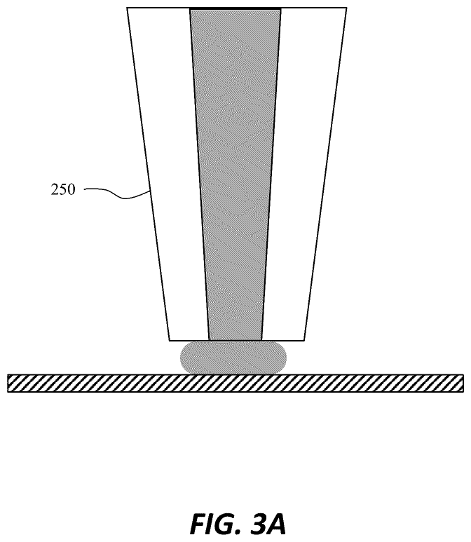

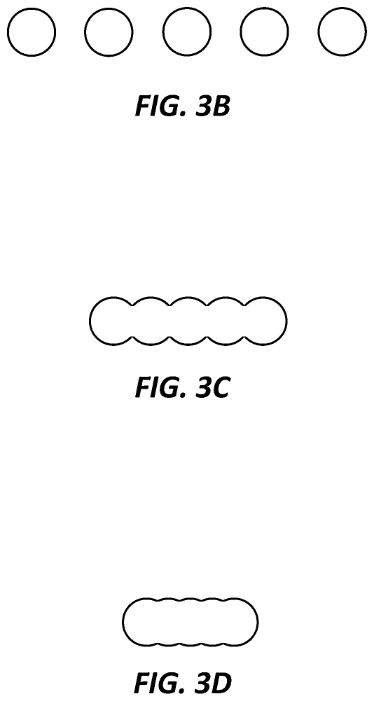

FIG. 3A illustrates droplet ejection that constrains the ejected droplet based on relative positioning of the nozzle 250 relative to the build platen 16 or prior layer of print material, in accordance with one embodiment. As shown in FIG. 3A, droplets are ejected or extruded into a space constrained by the tip of the nozzle 250 (which may be flat) and the target surface. The ejection height (also often referred to as “working distance”) between the tip of the nozzle 250 (which may be flat) and the target surface may be relatively short, e.g., smaller than a diameter of the ejected droplet (when unconstrained), causing the ejected droplet to be compressed or “squashed” against the target surface. As a result, the ejected droplets are prevented from flying into a free space before contacting the build platen 16 or prior layer of print material, and high placement accuracy of the ejected droplets is achieved.

FIGS. 3B-3D illustrates droplet placement outcomes based on different print head speeds and/or ejection heights, for comparison. FIG. 3B illustrates an exemplary result of droplet placement where the droplets become individual spaced droplets on the target surface, rather than combining to form a continuous segment. This result may occur when the ejection height is relatively high, such that the ejected droplets fly in free space before contacting the surface which causes reduction in target accuracy, especially when the high ejection height is combined with a relatively high ejection frequency. As shown in FIG. 3B, the droplets contact the surface as individual spaced droplets rather than forming a continuous segment.

Even in the case of a short ejection height as set forth in one aspect of the present invention, the result of FIG. 3B may occur if the movement speed of the print head is excessively high and the ejection frequency is not sufficiently high. By comparison, the result illustrated in FIG. 3C may be achieved by reducing the movement speed of the print head and/or increasing the ejection frequency. As shown in FIG. 3C, these droplets overlap to form a continuous segment rather than being individual spaced droplets, although the edges of the segment may be irregular due to the circular profile of individual droplets.

By comparison, the result illustrated in FIG. 3D may be achieved by even further reducing the movement speed of the print head and/or even further increasing the ejection frequency. As shown in FIG. 3D, the droplets continue to overlap to form a continuous segment but are even more closely compacted together in overlap, further reducing irregularities along the edges of the segment. It will be appreciated that the droplet results illustrated in FIG. 3C and/or FIG. 3D may not be achievable without reducing the ejection height to a height smaller than a diameter of the ejected droplet (when unconstrained) in order to compress the droplet against the target surface.

It will further be appreciated that the APD mechanism 200 allows for near-instantaneous stop/start control of droplet ejection, reducing the delays between a control command to eject print material and actual ejection of print material (including the ejection rate). Such favorable timing allows for extremely high droplet placement accuracy and control of individual droplets, particularly during movement of the print head, which may not be attainable with conventional 3D printing. Using the APD mechanism 200 of the present invention provides a 3D printing process that obviates the need to otherwise compensate for deviations between extrusion control commands and actual extrusion, such as compensation based on priming and/or retracting print material (e.g., filaments). Such advantages may be realized, for instance, when extruding material during high-speed stop-and-go type motion, when incorporating a jetting mode where need is obviated for compensation of time-of-flight and/or lateral momentum, and/or when obviating a need compensate for any imperfect motor drive system behavior in order to produce ideal beads of print material.

It will be noted that the arrangements described above are applicable to any of the operations described herein.

Operation for Continuous Extrusion Printing Using ATD

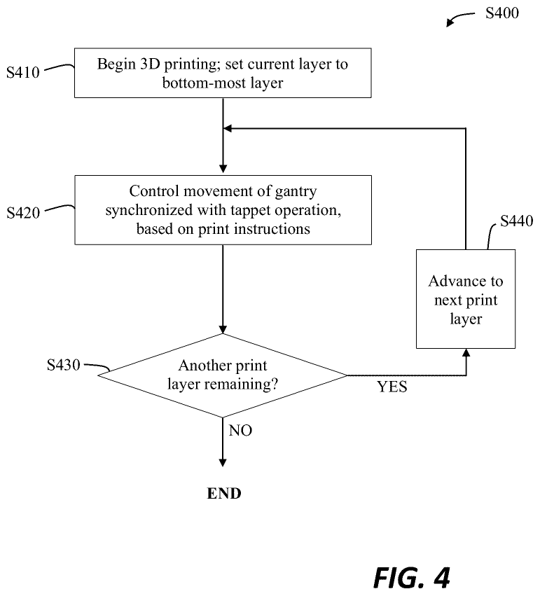

FIG. 4 illustrates an operation S400 for performing continuous extrusion printing using an ATD mechanism of the present invention, according to one embodiment.

First, in step S410, the controller 20 initiates the 3D-printing operation of the object, setting the current layer to be printed as the bottom-most print layer.

In step S420, the controller 20 controls the motors 116, 118 with motor commands to control movement of the gantry 1010, while concurrently controlling the ATD mechanism 200 to extrude print material. In particular, the controller 20 controls the piezo actuator 260 in synchronized timing with the control of the motors 116, 118, based on print instructions. As noted above, such synchronized control allows for precisely-timed coordination between extrusion and motion.

In step S430, the controller 20 determines whether another print layer remains to be printed for the object. If another print layer remains to be printed, the operation proceeds to step S440. If the current print layer is the final print layer, the operation ends.

In step S440, the controller 20 increments the current print layer to the next layer, thereby advancing to the next layer. Generally, the next layer is the successive layer upwards in height. The operation then returns to step S420.

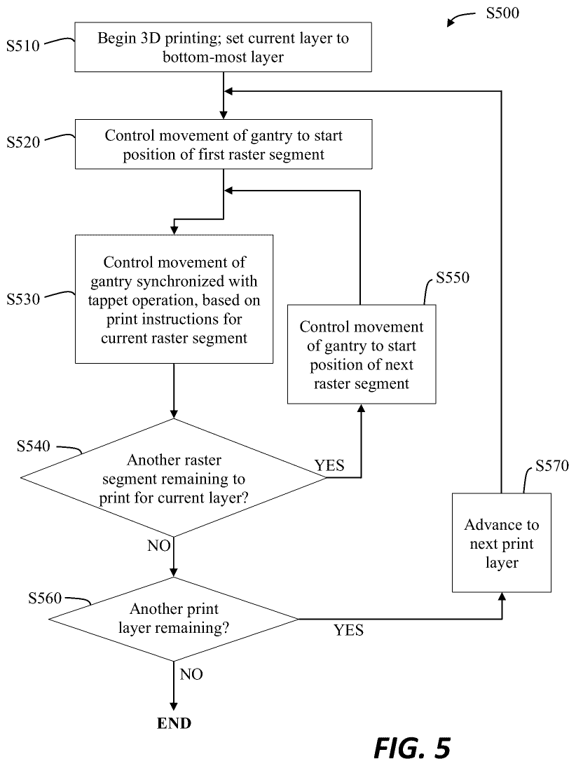

FIG. 5 illustrates an operation S500 for performing raster pattern printing using an ATD mechanism of the present invention, according to one embodiment. The operation S500 differs from the operation S400 by printing multiple discrete segments rather than continuous extrusion.

First, in step S510, the controller 20 initiates the 3D-printing operation of the object, setting the current layer to be printed as the bottom-most print layer.

In step S520, the controller 20 controls the motors 116, 118 with motor commands to control movement of the gantry 1010, thereby moving the gantry 1010 to the start position of a first raster segment to be printed. The segments may be linear, arcuate, or any other pattern. For instance, in the case of linear raster segments, the raster pattern may be an array of parallel lines. The motion may also be combined with any number of non-print-related motions including calibration, measurement, and/or cleaning.

In step S530, the controller 20 controls the motors 116, 118 with motor commands to control movement of the gantry 1010, while concurrently controlling the ATD mechanism 200 to extrude print material (similar to step S420). In particular, the controller 20 controls the piezo actuator 260 in synchronized timing with the control of the motors 116, 118, based on print instructions.

In step S540, the controller 20 determines whether another raster segment remains to be printed for the current layer, based on the print instructions. If another raster segment remains to be printed, the operation proceeds to step S550. If no more raster segments remain to be printed for the current layer, the operation proceeds to step S560.

In step S550, the controller 20 controls the motors 116, 118 with motor commands to control movement of the gantry 1010, to move the nozzle 250 of the ATD mechanism 200 to the start position of the next raster segment to be printed for the current layer. The operation then returns to step S530.

In step S560, the controller 20 determines whether another print layer remains to be printed for the object. If another print layer remains to be printed, the operation proceeds to step S570. If the current print layer is the final print layer, the operation ends.

In step S570, the controller 20 increments the current print layer to the next layer, thereby advancing to the next layer. Generally, the next layer is the successive layer upwards in height. The operation then returns to step S520.

The operation S500 may be used in both FFF and MEX printing. For instance, in the case of FFF printing, the operation S500 may deposit molten print material (e.g., plastic) in a linear raster array pattern mode, thereby depositing material as an array of parallel lines (or “beads”) of different lengths. The operation S500 may form an array of outer boundaries based on the beginnings and ends of parallel beads. In the case of MEX printing, the operation S500 may employ a droplet jetting regime, such that individual jetted droplets merge on the substrate surface to form a continuous line (bead).

The raster pattern printing of operation S500 may realize various advantages including drastically increased printing speed, especially in the cases of printing multiple parts on the same build platen and printing particularly large parts which occupy the entire build platen. Such advantage of increased printing speed is realized because the print head can traverse the entire length or width of the build platen linearly at high speed without acceleration or deceleration before moving to the next raster segment. In this regard, the raster pattern printing of operation S500 may be advantageous in defining the shape and structure of a particular layer of a 3D-printed part.

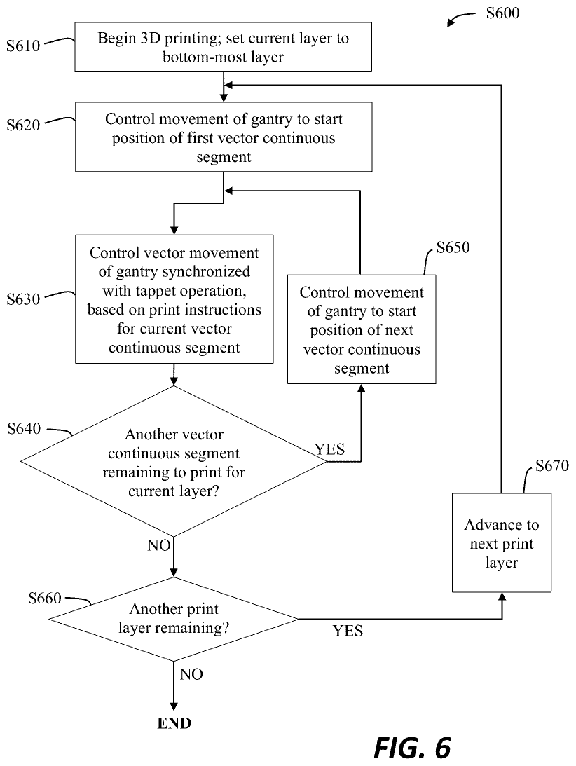

FIG. 6 illustrates an operation S600 for performing vector continuous printing using an ATD mechanism of the present invention, according to one embodiment. The operation S600 differs from the operation S500 by printing multiple segments based on discrete vectors rather than based on raster segments.

First, in step S610, the controller 20 initiates the 3D-printing operation of the object, setting the current layer to be printed as the bottom-most print layer.

In step S620, the controller 20 controls the motors 116, 118 with motor commands to control movement of the gantry 1010, thereby moving the gantry 1010 to the start position of a first vector continuous segment to be printed. The motion may also be combined with any number of non-print-related motions including calibration, measurement, and/or cleaning.

In step S630, the controller 20 controls the motors 116, 118 with motor commands to control movement of the gantry 1010, while concurrently controlling the ATD mechanism 200 to extrude print material (similar to step S420). In particular, the controller 20 controls the piezo actuator 260 in synchronized timing with the control of the motors 116, 118, based on print instructions.

In step S640, the controller 20 determines whether another vector continuous segment remains to be printed for the current layer, based on the print instructions. If another vector continuous segment remains to be printed, the operation proceeds to step S650. If no more vector continuous segments remain to be printed for the current layer, the operation proceeds to step S660.

In step S650, the controller 20 controls the motors 116, 118 with motor commands to control movement of the gantry 1010, to move the nozzle 250 of the ATD mechanism 200 to the start position of the next vector continuous segment to be printed for the current layer. The operation then returns to step S630.

In step S660, the controller 20 determines whether another print layer remains to be printed for the object. If another print layer remains to be printed, the operation proceeds to step S670. If the current print layer is the final print layer, the operation ends.

In step S670, the controller 20 increments the current print layer to the next layer, thereby advancing to the next layer. Generally, the next layer is the successive layer upwards in height. The operation then returns to step S620.

The vector continuous printing mode may provide certain advantages over a raster pattern printing mode by providing the capability to deposit print material in a free-form shape, rather than being limited to raster segments, at the potential cost of a slower print speed. The free-form capabilities allow for maximum deposition path length and minimum starts and stops are otherwise may be difficult to control using conventional PWM extrusion, thereby being useful for printing high-definition features. In general, extrusion using the ATD approach of the present invention may provide improved printing over conventional PWM extrusion, as a result of the high pressure exerted by the tappet on molten print material (e.g., plastic) when it approaches the nozzle opening. Such high pressure provided by the ATD approach of the present invention allows for smaller extrusion nozzle diameters, which in turn allows for higher-definition printing of part features. The high pressure of the ATD approach also allows for longer nozzle bore length, non-round orifice shapes, higher viscosity materials, or more generally, any kind of nozzle and material system (e.g., two material concentric co-extrusion, or operation at lower temperatures or semi-solid states) which requires greater force than conventional extrusion mechanisms. The high pressure of the ATD approach further allows for the near-instantaneous start-stop capability described above.

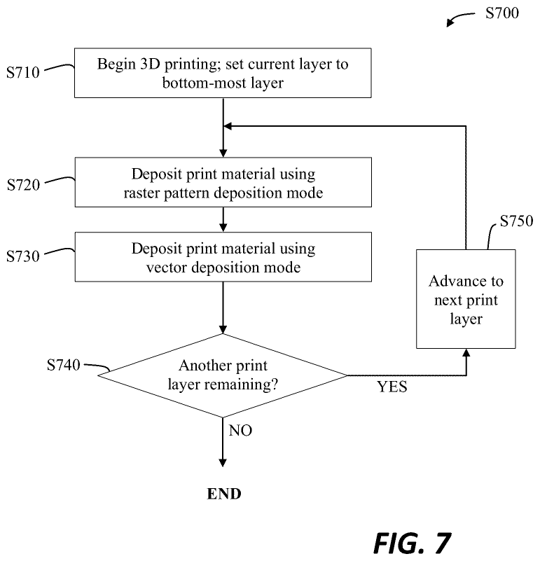

FIG. 7 illustrates an operation S700 for performing mixed raster pattern and vector printing using an ATD mechanism of the present invention, according to one embodiment. The operation S700 differs from the operations S400, S500, and S600 by printing both raster pattern segments and vector continuous segments. The operation S700 may be used, for example, as a continuous extrusion mode for printing molten material (e.g., plastic-based) or non-molten material (e.g., non-molten material MEX) and/or for FFF printing.

It will be recognized that prior to performing the operation S700, print instructions have been established to include, for each layer, control commands based on print segments that include one or both of raster segments and vector continuous segments.

In step S710, the controller 20 initiates the 3D-printing operation of the object, setting the current layer to be printed as the bottom-most print layer.

In step S720, the controller 20 deposits print material by performing a raster pattern printing deposition. For example, the controller 20 may perform steps S520, S530, S540, and S550 within operation S500, as described above, to print all raster segments for the current layer.

In step S730, the controller 20 deposits print material by performing a vector continuous printing operation. For example, the controller 20 may perform steps S620, S630, S640, and S650 within operation S600, as described above, to print all vector continuous segments for the current layer.

In step S740, the controller 20 determines whether another print layer remains to be printed for the object. If another print layer remains to be printed, the operation proceeds to step S750. If the current print layer is the final print layer, the operation ends.

In step S750, the controller 20 increments the current print layer to the next layer, thereby advancing to the next layer. Generally, the next layer is the successive layer upwards in height. The operation then returns to step S720.

It will be appreciated that the combination of the raster pattern deposition and the vector continuous deposition allows for the advantages of each mode to be utilized. For example, the raster pattern deposition mode may provide fast printing speeds relative to the vector continuous deposition mode to produce the raster pattern, while the vector continuous deposition mode may provide improved definition of outer boundaries of the previously-printed raster pattern.

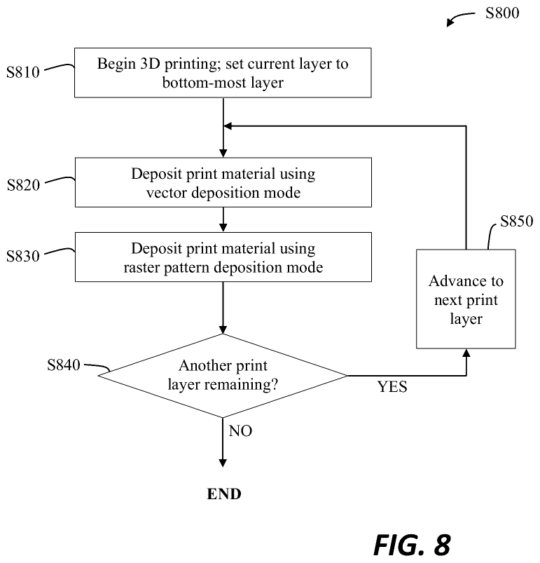

FIG. 8 illustrates an operation S800 for performing mixed raster pattern and vector printing using an ATD mechanism of the present invention, according to one embodiment. The operation S800 differs from the operation S700 by reversing the order in which the raster pattern deposition mode and the vector continuous deposition mode are performed, such that the vector continuous deposition mode is performed first before the raster pattern deposition mode in forming each print layer. It will be appreciated that operation S800 may be used, for example, to first print outer boundaries of a shape using the vector continuous deposition mode, followed by in-filling the outer boundaries using the raster pattern deposition mode. The operation S800 may be used, e.g., as a continuous extrusion mode for printing molten print material (e.g., plastic-based).

In step S810, the controller 20 initiates the 3D-printing operation of the object, setting the current layer to be printed as the bottom-most print layer.

In step S820, the controller 20 deposits print material by performing a vector continuous printing operation. For example, the controller 20 may perform steps S620, S630, S640, and S650 within operation S600, as described above, to print all vector continuous segments for the current layer.

In step S830, the controller 20 deposits print material by performing a raster pattern printing deposition. For example, the controller 20 may perform steps S520, S530, S540, and S550 within operation S500, as described above, to print all raster segments for the current layer.

In step S840, the controller 20 determines whether another print layer remains to be printed for the object. If another print layer remains to be printed, the operation proceeds to step S850. If the current print layer is the final print layer, the operation ends.

In step S850, the controller 20 increments the current print layer to the next layer, thereby advancing to the next layer. Generally, the next layer is the successive layer upwards in height. The operation then returns to step S820.

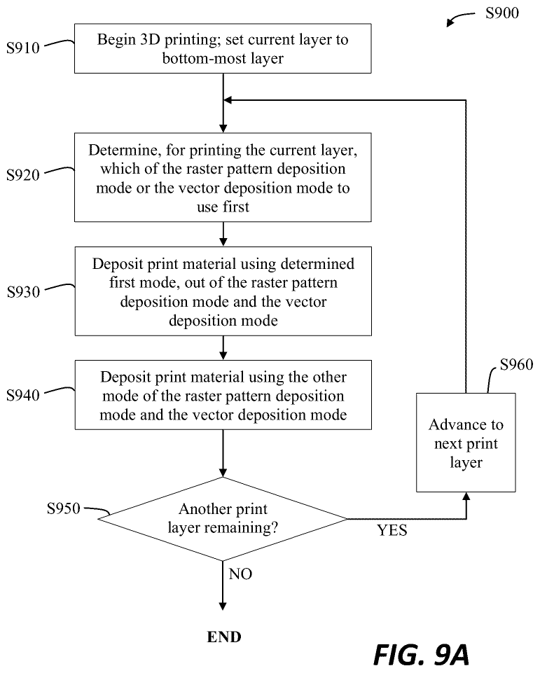

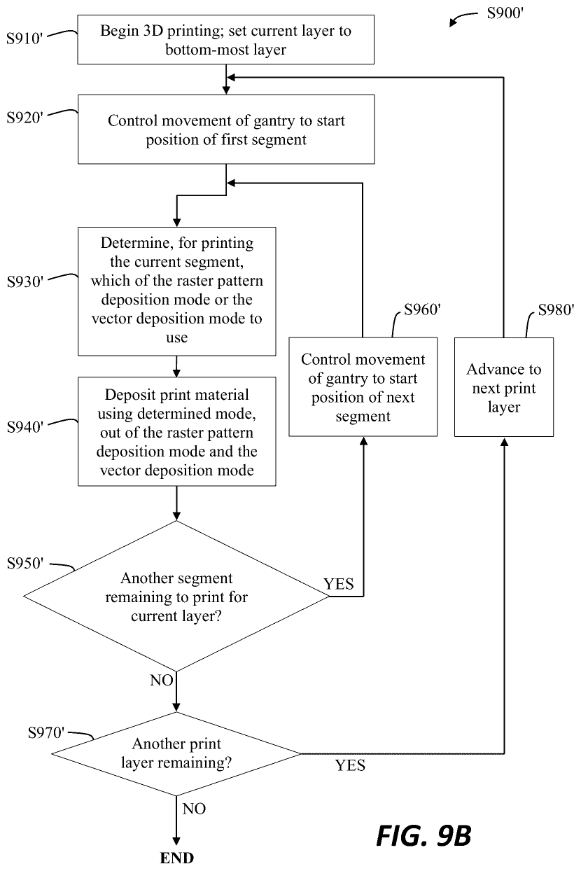

FIG. 9A illustrates an operation S900 for performing mixed raster pattern and vector printing using an ATD mechanism of the present invention, according to one embodiment. The operation S900 differs from the operation S700 by determining, on a layer-by-layer basis, whether to first utilize raster pattern deposition mode or the vector deposition mode.

In step S910, the controller 20 initiates the 3D-printing operation of the object, setting the current layer to be printed as the bottom-most print layer.

In step S920, the controller 20 determines, for the printing of the current layer, which of the raster pattern deposition mode and the vector deposition mode to perform first. Such determination may be based on, for example, print properties such as speed or the cooling of extruded material, or final part properties such as density, surface finish and dimensional accuracy. As another example, the determination may be based on whether a shell of a 3D pattern is being printed first or an infill of the 3D pattern is being printed first. If the controller 20 determines that the shell is being printed first, the controller 20 may determine to perform the vector deposition mode first, and if the controller 20 determines that the infill is being printed first, the controller 20 may determine to perform the raster pattern deposition mode first. The remaining mode, of the raster pattern deposition mode and the vector deposition mode, is determined to be performed second.

In step S930, the controller 20 deposits print material by performing the mode, of the raster pattern deposition mode and the vector deposition mode, that was determined in step S920 to perform first. For instance, in the case that it was determined in step S920 to first perform the raster pattern printing deposition, the controller 20 may perform steps S520, S530, S540, and S550 within operation S500, as described above, to print all raster segments for the current layer. And in the case that it was determined in step S920 to first perform the vector continuous printing deposition, the controller may perform steps S620, S630, S640, and S650 within operation S600, as described above, to print all vector continuous segments for the current layer.

In step S940, the controller 20 deposits print material by performing the remaining mode, of the raster pattern deposition mode and the vector deposition mode, that was determined in step S920 to be performed second.

In step S950, the controller 20 determines whether another print layer remains to be printed for the object. If another print layer remains to be printed, the operation proceeds to step S960. If the current print layer is the final print layer, the operation ends.

In step S960, the controller 20 increments the current print layer to the next layer, thereby advancing to the next layer. Generally, the next layer is the successive layer upwards in height. The operation then returns to step S920.

FIG. 9B illustrates an operation S900′ for performing mixed raster pattern and vector printing using an ATD mechanism of the present invention, according to one embodiment.

The operation S900′ differs from the operation S900 by determining, on a segment-by-segment basis (rather than a layer-by-layer basis), whether to utilize raster pattern deposition mode or the vector deposition mode for printing a segment.

In step S910′, the controller 20 initiates the 3D-printing operation of the object, setting the current layer to be printed as the bottom-most print layer.

In step S920′, the controller 20 controls the motors 116, 118 with motor commands to control movement of the gantry 1010, thereby moving the gantry 1010 to the start position of a first vector continuous segment to be printed. The motion may also be combined with any number of non-print-related motions including calibration, measurement, and/or cleaning.

In step S930′, the controller 20 determines, for the printing of the current segment, which of the raster pattern deposition mode and the vector deposition mode to use. Such determination may be based on, for example, the properties of the segment. As another example, the determination may be based on whether the segment corresponds to a shell of a 3D pattern is being printed first or corresponds to an infill of the 3D pattern. If the controller 20 determines that the segment corresponds to a shell, the controller 20 may determine to print the segment using the vector deposition mode, and if the controller 20 determines that the segment corresponds to an infill, the controller 20 may determine to print the segment using the raster pattern deposition mode.

In step S940′, the controller 20 deposits print material by performing the mode, of the raster pattern deposition mode and the vector deposition mode, that was determined in step S930′ to perform first. For instance, in the case that it was determined in step S930′ to print the segment using raster pattern deposition, the controller 20 may perform step S530 within operation S500, as described above, to print the segment as a raster segment. And in the case that it was determined in step S930′ to print the segment using vector continuous printing deposition, the controller may perform step S630 within operation S600, as described above, to print the segment as a vector continuous segment.

In step S960′, the controller 20 advances to the next segment, and the controller 20 controls the motors 116, 118 with motor commands to control movement of the gantry 1010, to move the nozzle 250 of the ATD mechanism 200 to the start position of the next segment to be printed for the current layer. The operation then returns to step S930′. If no more segments remain to be printed for the current layer, the operation proceeds to step S970′.

In step S970′, the controller 20 determines whether another print layer remains to be printed for the object. If another print layer remains to be printed, the operation proceeds to step S980′. If the current print layer is the final print layer, the operation ends.

In step S980′, the controller 20 increments the current print layer to the next layer, thereby advancing to the next layer. Generally, the next layer is the successive layer upwards in height. The operation then returns to step S920′.

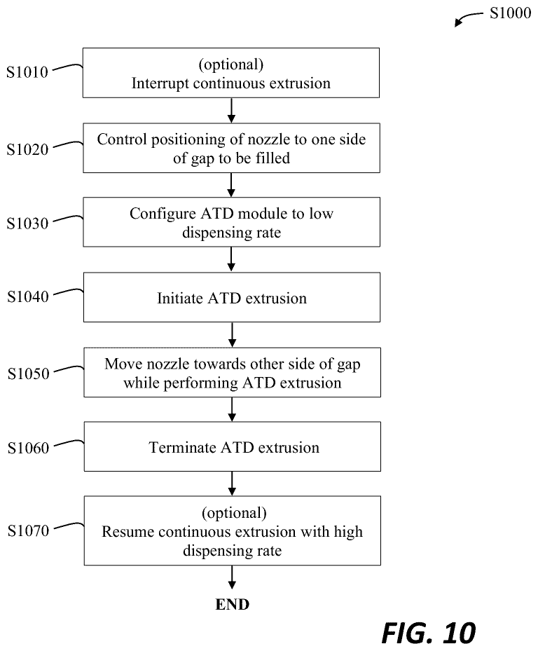

FIG. 10 illustrates an operation S1000 for performing a gap bridging printing mode, according to one embodiment. The operation S1000 may be used, for example, with MEX printing and/or FFF printing.

The operation S1000 may be especially useful when used in conjunction with an ATD mechanism of the present invention, which provides a continuous extrusion mode and high dispensing rates. The gap bridging printing mode based on the operation S1000 may be most effective when the surface to be printed is located close to the nozzle (e.g., about or less than one nozzle ID diameter distance)

The gap bridging printing mode may involve depositing print material that bridges a small gap (e.g., <1 mm wide) between printed segments, such that no support for an extruded bead is required in order for an extruded filament to maintain cohesion as the extruded filament bridges the gap.

The gap bridging printing mode may also involve, when printing in empty space, transitioning the printing from continuous extrusion to discrete droplet jetting. That is, the apparatus may transition to a low dispensing rate (e.g., based on a lower tappet reciprocating frequency) when dispensing print material to bridge a gap. After passing over the gap, the ATD mechanism may transition back to a high dispensing rate (e.g., based on a higher tappet reciprocating frequency) to maintain overall high printing speed.

In (optional) step S1010, the controller 20 interrupts an ongoing continuous extrusion operation to switch to the gap bridging printing mode. For instance, this interruption may occur where the controller 20 recognizes that an undesirable gap in material deposition has occurred during a printing operation and should be resolved by using gap bridging. Such recognition of a gap may occur, for example, based on data from optical and/or contact sensors which monitor aspects of the printing operation, based on computer analysis of the print geometry, error recovery features (e.g., power loss or interruption in computation or printing), detection of contamination (e.g., gas) in the melt zone, detection of attempted printing when the melt zone contained insufficient molten material, detection of temperature anomalies during a print operation, detection of a discrepancy in expected mass transport, and/or any other number of triggers.

In step S1020, the controller 20 controls the motors 116, 118 with motor commands to control movement of the gantry 1010, so as to position the nozzle 250 of the ATD mechanism 200 on one side of an identified gap to be filled.

In step S1030, the controller 20 controls the ATD mechanism 200 to be configured for a lower dispensing rate.

In step S1040, the controller 20 controls the ATD mechanism 200 to initiate the extrusion of print material.

In step S1050, the controller 20 controls the motors 116, 118 with motor commands to control movement of the gantry 1010 so as to move the nozzle 250 of the ATD mechanism 200 towards the other side of the gap, while concurrently controlling the ATD mechanism 200 to extrude print material.

In step S1060, the controller 20 controls the ATD mechanism 200 to terminate extrusion when the nozzle has reached the other side of the gap.

In (optional) step S1070, the controller 20 controls the ATD mechanism 200 to be configured for a high dispensing rate and resumes continuous extrusion. In scenarios where the gap bridging printing is performed after completion of continuous extrusion, steps S1010 and S1070 may be omitted.

In the case that multiple gaps are present, after step S1050 has been performed for the first defect, steps S1020, S1030, S1040, and S1050 may be repeatedly performed to correct each remaining defect.

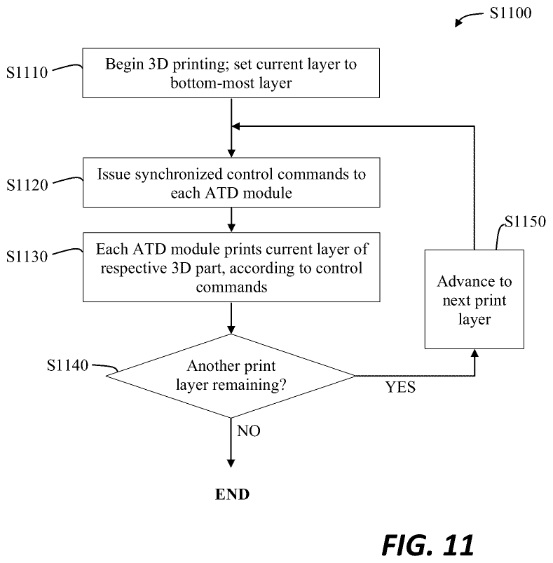

FIG. 11 illustrates an operation S1100 for performing a multi-nozzle printing mode, according to one embodiment. The multi-nozzle printing mode in operation S1100 may be used to operate multiple ATD mechanisms to, for example, print multiple copies of a 3D part and/or concurrently print different portions of a single part. By operating multiple nozzles concurrently, the multi-nozzle printing mode may increase the overall printing speed. The operation S1100 may be used, for example, with MEX printing (e.g., non-molten material MEX) and/or FFF printing.

The operation S1100 involves an apparatus 1000 that includes multiple ATD mechanisms, each one having its own nozzle through which to extrude print material (e.g., molten plastic material in a continuous extrusion mode). For example, the operation may perform a multi-nozzle raster pattern deposition mode (e.g., the operation S500, applied to multiple nozzles), where each nozzle may print separate raster segments and the position and length of each printed raster segment may be determined by the controller 20 based on the printed part geometry. The operation may perform a multi-nozzle vector continuous deposition mode (e.g., the operation S600, applied to multiple nozzles), where each nozzle may print separate vector continuous segments as determined by the controller 20 based on the printed part geometry. The operation may perform a multi-nozzle mixed raster pattern and vector continuous deposition mode (e.g., one of the operations S700, S800, or S900, applied to multiple nozzles), where each nozzle may print both separate raster segments and separate vector continuous segments as determined by the controller 20 based on the printed part geometry.

The operation may perform a continuous extrusion mode multi-part parallel printing mode of printing identical parts, where each nozzle is assigned to printing a different copy of the part. In such an operation, the ATD mechanisms may be positioned at a distance from each other, with synchronized nozzle extrusion and movement synchronized among all of the ATD mechanisms to print separate copies of the part.

The operation may perform a discrete particle jetting mode, where print material (e.g., molten plastic material) is deposited in a multi-nozzle raster pattern mode or multi-part parallel printing mode.

It will be recognized that prior to performing the operation S1100, print instructions have been established to include control commands defining the synchronized operation of each ATD mechanism 200 (e.g., movement and extrusion timing).

In step S1110, the controller 20 initiates the 3D-printing operation of the object, setting the current layer to be printed as the bottom-most print layer.

In step S1120, the controller 20 issues synchronized control commands to each ATD mechanism 200.

In step S1130, each ATD mechanism 200 operates based on the respective control commands from step S1120, to print the current layer of one or more respective 3D parts.

In step S1140, the controller 20 determines whether another print layer remains to be printed for the one or more objects. If another print layer remains to be printed, the operation proceeds to step S1150. If the current print layer is the final print layer, the operation ends.

In step S1150, the controller 20 increments the current print layer to the next layer, thereby advancing to the next layer. Generally, the next layer is the successive layer upwards in height. The operation then returns to step S1120.

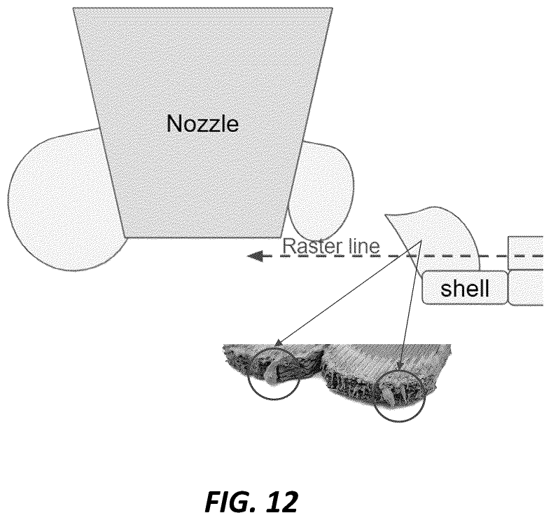

FIG. 12 illustrates the cleaning of the nozzle 250 of the ATD mechanism 200 using a cleaning component such as the cleaning stations 22 (e.g., brushes 22a) and/or one or more 3D-printed features separate from the 3D part which are 3D printed in advance for this purpose. Such cleaning may be used in connection with MEX printing and/or FFF printing.

With respect to the case of one or more separate features to be 3D-printed for use in the cleaning, one or more separate features (e.g., perimeter, dam, and/or scraper) may be printed for use in removing unwanted extrudate. These features are used during the 3D printing operation to accumulate and/or scrape excess print material to prevent such material from forming part of the 3D part. In one embodiment, the features are used to scrape any undesirable excess print material from the print nozzle. These features are then disposed of after the print operation is complete.

Whether the cleaning component used is a cleaning station 22 or a 3D-printed feature, the cleaning may be performed when operating in raster pattern printing mode. For example, in one embodiment, the controller 20 may control the nozzle 250 to be cleaned twice for each linear raster movement, by moving the nozzle 250 across the cleaning component after the nozzle 250 has completed its raster print movement. That is, each raster print movement may involve a full movement across the entire length (or width) of the build platen 16 and passing through the respective cleaning component. In one embodiment, the controller 20 may control the nozzle 250 to be cleaned after a certain number of raster passes. In one embodiment, the controller 20 may control the nozzle 250 to be cleaned after each layer is printed.

The cleaning may be performed when operating in vector continuous printing mode. For example, in one embodiment, the controller 20 may control the nozzle 250 to be cleaned after each vector continuous segment is deposited, by moving the nozzle to the closest cleaning component and across that cleaning component one or more times. In one embodiment, the controller 20 may control the nozzle 250 to be cleaned after a certain number of vector continuous segments are deposited. In one embodiment, the controller 20 may control the nozzle 250 to be cleaned after a certain aggregate length of print material deposition has occurred. In one embodiment, the controller 20 may control the nozzle 250 to be cleaned after each layer is printed.

The cleaning may be performed when operating in a mixed raster pattern and vector printing mode. For example, in one embodiment, the controller 20 may control the nozzle 250 to be cleaned according to, when performing the raster pattern printing portion, one or more of the raster pattern cleaning approaches described above, and when performing the vector continuous printing portion, one or more of the vector continuous cleaning approaches described above. In one embodiment, the controller 20 may control the nozzle 250 to be cleaned after a certain number of segments (whether raster or vector continuous) are deposited. In one embodiment, the controller 20 may control the nozzle 250 to be cleaned after a certain aggregate length of print material deposition has occurred. In one embodiment, the controller 20 may control the nozzle 250 to be cleaned after each layer is printed.

For any of the above cleaning approaches, in a case that the controller 20 determines that additional cleaning is needed beyond a single pass through the cleaning component, the controller 20 may control movement of the nozzle 250 such that the nozzle 250 is reciprocated multiple times across the cleaning component. In the case that the apparatus includes multiple ATD mechanisms 200 and multiple nozzles 250, one or more of the above approaches may be applied to each of the nozzles 250, such that cleaning of each nozzle 250 is performed either independent of the other nozzles 250 or in coordination with the other nozzles 250.

Ultimately, it will be appreciated that any number of variables may be utilized as to the determination by the controller 20 of when the cleaning of a nozzle 250 should be performed.

It will be appreciated that the cleaning stations 22 (e.g., brushes 22a) and/or the separate 3D-printed features may have broader applicability beyond just cleaning the nozzle 250 of the ATD mechanism 200, to include (but not be limited to) cleaning of other components of the apparatus.

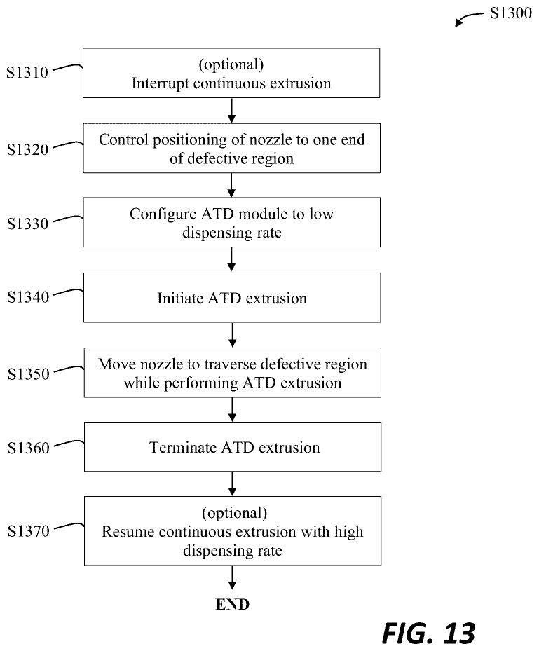

FIG. 13 illustrates an operation S1300 for performing a spot correction printing mode, according to one embodiment. The operation S1300 may be used, for example, with MEX printing (e.g., non-molten material MEX) and/or FFF printing.

The operation S1300 may be especially useful when used in conjunction with an ATD mechanism of the present invention, in that the ATD mechanism 200 allows precise control of extrusion amount, down to a single jetted droplet.

The spot correction printing mode may involve “patching” regions having print defects (e.g., under-extrusion) by returning to these regions after the initial extrusion to deposit additional print material to resolve the defect. The initial print defects may have occurred due to, for example, pathing and deposition limitations. As non-limiting examples, initial deposition of print material may have resulted in small gaps where a print material bead could not fit, or pinhole defects where an end radius of a bead does not match a contoured sidewall.

The precise delivery of small volumes of material provided by the ATD mechanism 200 of the present invention may allow for defects to be satisfactorily corrected, while delivering reduced microporosity, increased strength, and better shell-to-infill bonding.

In (optional) step S1310, the controller 20 interrupts an ongoing continuous extrusion operation to switch to the spot correction printing mode. For instance, this interruption may occur where the controller 20 recognizes that an undesirable defect in material deposition has occurred during a printing operation and should be resolved by using spot correction. Such recognition of a defect may occur, for example, based on (i) data from sensors (e.g., optical) which monitor aspects of the printing operation, (ii) known defect circumstances or locations which may be predicted and recognized without requiring sensor detection, and/or based on user input, prior print performance, aggregated fleet data, predictive algorithms, etc.

In step S1320, the controller 20 controls the motors 116, 118 with motor commands to control movement of the gantry 1010, so as to position the nozzle 250 of the ATD mechanism 200 to one end of the region of a defect to be corrected.

In step S1330, the controller 20 controls the ATD mechanism 200 to be configured for a low dispensing rate.

In step S1340, the controller 20 controls the ATD mechanism 200 to initiate the extrusion of print material.

In step S1350, the controller 20 controls the motors 116, 118 with motor commands to control movement of the gantry 1010 so as to move the nozzle 250 of the ATD mechanism 200 to traverse the defect, while concurrently controlling the ATD mechanism 200 to extrude print material. In circumstances where the defect is relatively small and does not require nozzle movement to “patch”, the movement of the nozzle may be omitted in step S1350.

In step S1360, the controller 20 controls the ATD mechanism 200 to terminate extrusion when the nozzle has completed the “patching” of the defect.

In (optional) step S1370, the controller 20 controls the ATD mechanism 200 to be configured for a high dispensing rate and resumes continuous extrusion. In scenarios where the spot correction printing is performed after completion of continuous extrusion, steps S1310 and S1370 may be omitted.

In the case that multiple defects are present, after step S1350 has been performed for the first defect, steps S1320, S1330, S1340, and S1350 may be repeatedly performed to correct each remaining defect.

It will be recognized that in a fully performant system, a predictive, open-loop step may be skipped, and a reactive, closed-loop system can discover all defects, expected or otherwise.

Another advantage that may be realized by the ATD mechanism of the present invention includes predictive and/or real time control of extrusion bead width. Such control allows an “on-the-fly” change in material bead width that generally cannot be achieved in conventional FFF printing, thereby allowing precise pathing of small features for accurate deposition. For instance, in conventional FFF printing which may utilize PWM for controlling an extruder via a pinch wheel, the PWM control may result in excess time lag between the control and the resulting extrusion. Such slower reaction time between an increase in extrusion pressure and increased extrusion may prevent a practical implementation of precise extrusion bead width control. Using the ATD mechanism of the present invention, smaller features can be printed by changing the extrusion rate “on-the-fly”, while keeping toolhead pathing simplified and optimally efficient.

Additional improvements that will be recognized as encompassed by the present invention include, but are not limited to:
(1) Continuous feeding—Conventional printing systems may load feedstock in discrete slugs which requires a pause for reloading. Such pause may introduce defects at each discontinuity in feedstock, defects elsewhere on the layer with the discontinuity, and/or defects on subsequent print layers formed on top of the discontinuity. By providing the capability to continuously deliver print material according to the present invention, discontinuous reloading may be avoided.
(2) Avoidance of need for pressurized gas supply—Conventional printing systems may require a constant pressurized gas supply, such as a connection to compressed gas cylinders or shop air. Such requirement may be avoided by using the ATD mechanism of the present invention. For example, the ATD mechanism may be mechanically driven by the piezo actuator rather than being driven by compressed gas. And, the feeding channel may be driven by a PWM rather than compressed gas.
(3) Alternative cooling techniques—Conventional printing systems may also utilize a pressurized gas supply for cooling the system components. Since the present invention may not require a separate pressurized gas supply, the apparatus does not need to depend on pressurized gas for any required cooling functions. By avoiding the need for pressurized gas, the present invention may take advantage of and utilize other cooling approaches, such as (but not limited to) a thermoelectric/Peltier system, a passive heat pipe system, and water cooling.
(4) Integral control electronics—Conventional printing systems may require multiple standalone controller units. The present invention may avoid the need for multiple controllers and provide a single controller integrated with the ATD mechanism 200 that provides continuous print material delivery and other functions (e.g., controlling both piezo actuation functions and thermal control). By avoiding the need for multiple controllers, the amount of wiring may be advantageously decreased and the physical arrangement of the apparatus may be simplified (e.g., functions may be physically reduced to a print head-mounted daughterboard controlling the piezo actuation functions that requires only power and data connections).

### Other Embodiments

Incorporation by reference is hereby made to U.S. Pat. Nos. 10,076,876, 9,149,988, 9,579,851, 9,694,544, 9,370,896, 9,539,762, 9,186,846, 10,000,011, 10,464,131, 9,186,848, 9,688,028, 9,815,268, 10,800,108, 10,814,558, 10,828,698, 10,953,609, U.S. Patent Application Publication No. 2016/0107379, U.S. Patent Application Publication No. 2019/0009472, U.S. Patent Application Publication No. 2020/0114422, U.S. Patent Application Publication No. 2020/0361155, U.S. Patent Application Publication No. 2020/0371509, and U.S. Provisional Patent Application No. 63/138,987 in their entireties.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

The following clauses define various aspects and optional features of the disclosure:

Clause 1. A 3D printing apparatus comprising:
a controller;
a dispensing mechanism configured to dispense 3D print material, wherein the dispensing mechanism includes:
   a driver,
   a chamber configured to accommodate the driver therein, the chamber including an input port configured to receive 3D print material entering the chamber and an output port configured to provide 3D print material exiting the chamber, and
   a driving mechanism that drives the driver with reciprocating movement within the chamber, based on signals from the controller,
   wherein the reciprocation of the driver causes print material within the chamber to exit the chamber via the output port; and
a nozzle coupled to the output port.

Clause 2. The 3D printing apparatus of Clause 1, wherein the driving mechanism includes a piezo actuator.

Clause 3. The 3D printing apparatus of any preceding clause, wherein the driver and the driving mechanism are configured as a tappet.

Clause 4. The 3D printing apparatus of any preceding clause, wherein the driver is formed of one or more of silicon carbon, tungsten carbide, tungsten, tool steels, and diamond.

Clause 5. The 3D printing apparatus of any preceding clause, wherein the controller is configured to control the driving mechanism to transition between reciprocating at a lower frequency corresponding to a lower print material dispensing rate and a higher frequency corresponding to a higher print material dispensing rate.

Clause 6. The 3D printing apparatus of any preceding clause, wherein the dispensing mechanism further comprises a supply mechanism to supply 3D print material.

Clause 7. The 3D printing apparatus of Clause 6, wherein the supply mechanism includes feeding and heating mechanisms, wherein the controller feeds 3D print material from the feeding mechanism to the heating mechanism to supply the heated 3D print material.

Clause 8. The 3D printing apparatus of Clause 6 or Claim 7, wherein the controller is configured to control the driving mechanism so as to drive the driver to cause 3D print material within the chamber to exit the chamber via the output port, even during a period when the supply mechanism is not supplying 3D print material.

Clause 9. The 3D printing apparatus of Clause 6 or Clause 7, wherein the controller is configured to control the supply mechanism to continuously supply 3D print material.

Clause 10. The 3D printing apparatus of one of Clauses 6-9, further comprising a movement mechanism configured to move the dispensing mechanism, wherein the controller is configured to control the movement mechanism and the dispensing mechanism in synchronization so as to be operable in one of at least two print modes including a first print mode and a second print mode.

Clause 11. The 3D printing apparatus of Clause 10, wherein the first print mode is a raster printing mode.

Clause 12. The 3D printing apparatus of Clause 10 or Clause 11, wherein the second print mode is a vector printing mode.

Clause 13. The 3D printing apparatus of any preceding clause, further comprising a cleaning mechanism configured to clean residual print material from the nozzle.

Clause 14. The 3D printing apparatus of Clause 13, wherein the cleaning mechanism includes a brush.

Clause 15. A method for 3D printing, comprising:
controlling a dispensing mechanism configured to dispense 3D print material, including:
controlling, based on signals from a controller, a driving mechanism to drive a driver with reciprocating movement within a chamber, the chamber including an input port configured to receive 3D print material entering the chamber and an output port configured to provide 3D print material exiting the chamber,
wherein the reciprocation of the driver causes print material within the chamber to exit the chamber via the output port.

Clause 16. The method of Clause 15, wherein the driving mechanism includes a piezo actuator.

Clause 17. The method of one of Clauses 15-16, wherein the driver and the driving mechanism are configured as a tappet.

Clause 18. The method of one of Clauses 15-17, wherein the controlling of the driving mechanism includes transitioning between reciprocating at a lower frequency corresponding to a lower print material dispensing rate and a higher frequency corresponding to a higher print material dispensing rate.

Clause 19. The method of one of Clauses 15-18, wherein the controlling of the dispensing mechanism includes controlling the dispensing mechanism to stop dispensing 3D print material without performing a retraction operation.

Clause 20. The method of one of Clauses 15-19, further comprising controlling a movement mechanism configured to move the dispensing mechanism, wherein the movement mechanism and the dispensing mechanism are controlled in synchronization to perform raster printing.

Clause 21. The method of Clause 20, wherein the movement mechanism and the dispensing mechanism are controlled in synchronization to perform raster printing to print a first print segment, and are controlled in synchronization to perform vector printing to print a second print segment.

Clause 22. The method of one of Clauses 15-21, further comprising performing a cleaning operation on the nozzle using a cleaning mechanism configured to clean residual print material from the nozzle.

Clause 23. The method of Clause 22, further comprising, prior to performing the cleaning operation, performing a 3D printing operation to 3D-print the cleaning mechanism.

1. A 3D printing apparatus comprising:
a controller;
a dispensing mechanism configured to dispense 3D print material, wherein the dispensing mechanism includes:
a driver,
a chamber configured to accommodate the driver therein, the chamber including an input port configured to receive 3D print material entering the chamber and an output port configured to provide the 3D print material exiting the chamber, and
a driving mechanism that drives the driver with reciprocating movement within the chamber, based on signals from the controller, thereby causing reciprocating movement of the driver,
wherein the reciprocation movement of the driver causes the 3D print material within the chamber to exit the chamber via the output port;
a movement mechanism configured to move the dispensing mechanism; and
a nozzle coupled to the output port,
wherein the controller is configured to control the movement mechanism and the dispensing mechanism in synchronization so as to be operable in one of at least two print modes including a first print mode and a second print mode,
wherein the first print mode is a raster printing mode and the second print mode is a vector printing mode.

2. The 3D printing apparatus of claim 1, wherein the driving mechanism includes a piezo actuator.

3. The 3D printing apparatus of claim 1, wherein the driver is configured as a tappet.

4. The 3D printing apparatus of claim 3, wherein the driver is formed of one or more of silicon carbon, tungsten carbide, tungsten, tool steels, and diamond.

5. The 3D printing apparatus of claim 1, wherein the controller is configured to control the driving mechanism to transition between reciprocating at a lower frequency corresponding to a lower print material dispensing rate and a higher frequency corresponding to a higher print material dispensing rate.

6. The 3D printing apparatus of claim 1, wherein the dispensing mechanism further comprises a supply mechanism to supply the 3D print material.

7. The 3D printing apparatus of claim 6, wherein the supply mechanism includes feeding and heating mechanisms, wherein the controller controls the feeding mechanism to feed the 3D print material from the feeding mechanism to the heating mechanism to supply the heated 3D print material.

8. The 3D printing apparatus of claim 6, wherein the controller is configured to control the driving mechanism so as to drive the driver to cause the 3D print material within the chamber to exit the chamber via the output port, even during a period when the supply mechanism is not supplying the 3D print material.

9. The 3D printing apparatus of claim 6, wherein the controller is configured to control the supply mechanism to continuously supply the 3D print material.

10-12. (canceled)

13. The 3D printing apparatus of claim 1, further comprising a cleaning mechanism configured to clean residual print material from the nozzle.

14. The 3D printing apparatus of claim 13, wherein the cleaning mechanism includes a brush.

15. A method for 3D printing, comprising:
controlling a dispensing mechanism configured to dispense 3D print material, including:
controlling, based on signals from a controller, a driving mechanism to drive a driver with reciprocating movement within a chamber, the chamber including an input port configured to receive 3D print material entering the chamber and an output port configured to provide 3D print material exiting the chamber,
wherein the reciprocation of the driver causes print material within the chamber to exit the chamber via the output port.

16. The method of claim 15, wherein the driving mechanism includes a piezo actuator.

17. The method of claim 15, wherein the driver and the driving mechanism are configured as a tappet.

18. The method of claim 15, wherein the controlling of the driving mechanism includes transitioning between reciprocating at a lower frequency corresponding to a lower print material dispensing rate and a higher frequency corresponding to a higher print material dispensing rate.

19. The method of claim 15, wherein the controlling of the dispensing mechanism includes controlling the dispensing mechanism to stop dispensing 3D print material without performing a retraction operation.

20. The method of claim 15, further comprising controlling a movement mechanism configured to move the dispensing mechanism,
wherein the movement mechanism and the dispensing mechanism are controlled in synchronization to perform raster printing.

21. The method of claim 20, wherein the movement mechanism and the dispensing mechanism are controlled in synchronization to perform raster printing to print a first print segment, and are controlled in synchronization to perform vector printing to print a second print segment.

22. The method of claim 15, further comprising performing a cleaning operation on the nozzle using a cleaning mechanism configured to clean residual print material from the nozzle.

23. The method of claim 22, further comprising, prior to performing the cleaning operation, performing a 3D printing operation to 3D-print the cleaning mechanism.

24. The 3D printing apparatus of claim 1, further comprising:
a platen configured to receive the 3D print material exiting the chamber via the output port; and
a motor that adjusts a height of the platen,
wherein the controller is configured to control the motor to set a height of the platen such that a distance between the nozzle and the platen is less than a width of an exit orifice of the nozzle.

25. The 3D printing apparatus of claim 24, wherein the controller is configured to control the movement mechanism and the dispensing mechanism in synchronization so as to form a segment of the 3D print material on the platen.

26. The 3D printing apparatus of claim 25, the controller is configured to control the movement mechanism and the dispensing mechanism in synchronization so as to deposit a plurality of droplets of the 3D print material on the platen so as to form the segment of the 3D print material on the platen.
